(19) United States
(12) Patent Application Publication
(10) Pub. No.: US 2017/0109879 A1
(43) Pub. Date: Apr. 20, 2017

(54) COMPUTER-IMPLEMENTED METHODS, COMPUTER-READABLE MEDIA, AND SYSTEMS FOR TRACKING A PLURALITY OF SPERMATOZOA

(71) Applicants: Drexel University, Philadelphia, PA (US); The Trustees of the University of Pennsylvania, Philadelphia, PA (US)

(72) Inventors: Leonardo Urbano, Philadelphia, PA (US); Moshe Kam, Maplewood, NJ (US); Puneet Masson, Philadelphia, PA (US); Matthew Vermilyea, Cedar Park, TX (US)

(73) Assignees: Drexel University, Philadelphia, PA (US); The Trustees of the University of Pennsylvania, Philadelphia, PA (US)

(21) Appl. No.: 15/128,003

(22) PCT Filed: Mar. 31, 2015
(86) PCT No.: PCT/US15/23725

§ 371 Date: Sep. 21, 2016

Related U.S. Application Data
(60) Provisional application No. 61/974,954, filed on Apr. 3, 2014.

(51) Int. Cl. G06T 7/00; G06T 7/11; G06T 7/90; G06T 7/136; G06T 7/70; G06K 9/62; G06K 9/00; G06T 7/20

(52) U.S. Cl. CPC G06T 7/0012; G06K 9/0014; G06T 7/11; G06T 7/20; G06T 7/136; G06T 7/70; G06K 9/6276; G06T 7/90; G06T 2207/10016; G06T 2207/10056; G06T 2207/30024; G06T 2207/10024; G06T 2210/41; G06T 7/155

(57) ABSTRACT

One aspect of the invention provides a computer-implemented method for tracking a plurality of spermatozoa. The method includes: identifying a coordinate for each of the plurality of spermatozoa in a plurality of video frames; and applying a nearest-neighbor joint probabilistic data association filter (NN-JPDAF) algorithm to associate the coordinates with one or a plurality of sperm tracks. Another aspect of the invention provides a non-transitory computer-readable medium containing program instructions executable by a processor. The computer-readable medium can include program instructions for performing a method as described herein. Another aspect of the invention provides a system including: a processor and a computer-readable medium including program instructions for performing a method as described herein.

### CROSS-REFERENCE TO RELATED APPLICATION

This application claims priority to U.S. Provisional Patent Application Ser. No. 61/974,954, filed Apr. 3, 2014. The entire content of this application is hereby incorporated by reference herein.

### BACKGROUND

Sperm counting, tracking, and classification is of significant interest to biologists studying sperm motion and to medical practitioners evaluating male infertility. A vast majority of sperm analysis is still performed manually by technicians using subjective visual analysis methods developed over 30 years ago. Namely, a lab technician looks at sperm under a microscope and counts and classifies sperm using pen and paper. Existing computer-based solutions such as CASA (computer-assisted sperm analysis) are prohibitively expensive, hard to use and don't track sperm—instead, they merely “connect-the-dots”—and therefore are severely limited for multi-sperm tracking in dense cell samples having frequent sperm collisions.

### SUMMARY OF THE INVENTION

One aspect of the invention provides a computer-implemented method for tracking a plurality of spermatozoa. The method includes: identifying a coordinate for each of the plurality of spermatozoa in a plurality of video frames; and applying a nearest-neighbor joint probabilistic data association filter (NN-JPDAF) algorithm to associate the coordinates with one or a plurality of sperm tracks.

This aspect of the invention can have a variety of embodiments. The method can further include applying a sperm segmentation algorithm to a plurality of video frames to identify sub-images potentially representing spermatozoa within the plurality of video frames. The sperm segmentation algorithm can include converting the plurality of video frames to grayscale. The sperm segmentation algorithm can include applying a detection threshold to a plurality of pixels within the plurality of video frames to produce a plurality of binary black-and-white images corresponding to the plurality of video images. The sperm segmentation algorithm can include applying Otsu's method to produce a plurality of binary black-and-white images corresponding to the plurality of video images.

The sperm segmentation algorithm can include applying one or more image processing algorithms on the pixels potentially representing the spermatozoa within the video frames. The one or more image processing algorithms can be selected from the group consisting of: close, erode, and dilate. The one or more image processing algorithms can remove pixels belonging to non-sperm particles and debris. The one or more image processing algorithms can discard groups of pixels having an area larger or smaller than a typical spermatozoa.

The method can further include calculating a centroid for a plurality of the sub-images.

The method can further include applying a multi-target tracking algorithm to estimate a mean sperm head position for each of the plurality of sperm tracks. The multi-target tracking algorithm can be selected from the group consisting of: a Kalman filter, an extended Kalman filter, a generalized pseudo-Bayesian estimator, a first-order generalized pseudo-Bayesian estimator, a second-order generalized pseudo-Bayesian estimator, and an interacting multiple model algorithm.

The method can further include calculating one or more kinematic parameters for each of the plurality of spermatozoa. The kinematic parameters can be selected from the group consisting of: curvilinear velocity, straight-line velocity, average path velocity, amplitude of lateral head displacement, linearity of curvilinear path, wobble, straightness, beat cross frequency, and mean angular displacement. The one or more kinematic parameters can be measured using only confirmed sperm tracks. The method can further include clustering measurements and tracks in each video frame using k-means clustering where a k-factor is calculated as a total number of tracks in the video frame divided by j, wherein j is a value between 10 and 20. A total number of motility parameter measurements collected per sperm can be limited to m, wherein m is a user-definable control parameter or a default value of m=5 seconds divided by a video frame rate. An animation of estimated paths of every tracked sperm can be superimposed on top of an original specimen video along with validation gates and unique track numbers. An animation of the bivariate histogram of the curvilinear velocity vs. straight-line velocity can be generated using confirmed track measurement data for all video frames up to a current video frame, the bivariate histogram drawn and animated for all video frames in the original video. An animation of the bivariate histogram of the path linearity vs. mean amplitude of lateral head displacement can be generated using the confirmed track measurement data for all video frames up to a current video frame, the bivariate histogram drawn and animated for all video frames in the original video.

The method can further include calculating a track score for each sperm track using a filter residual and residual covariance matrix.

A track can be deleted if a difference between its current track score and a maximum track score over its track history exceeds a track deletion threshold. A track can be confirmed if its track score exceeds a track confirmation threshold.

The method can further include coarsely associating measurements to each sperm track using a circular validation gate whose radius is calculated as a root mean square of a spermatozoa's spatial displacement over n most recent video frames, wherein n is a positive integer.

The method can further include calculating the total number of sperms in a sperm sample as the total number of confirmed tracks in every video frame divided by the total number of video frames. A percentage of motile sperms exhibiting progressive motility can be calculated as the total number of confirmed sperm tracks whose measured curvilinear velocity >25 μm/sec and path linearity >0.5, divided by the total number of confirmed sperm tracks. An average percentage of sperms exhibiting forward progression can be calculated as the sum of the percentage of sperms exhibiting forward progression over all video frames divided by the total number of video frames. A percentage of motile sperms exhibiting non-progressive motility can be calculated as the total number of confirmed sperm tracks whose measured curvilinear velocity >10 μm/sec and path linearity <0.5, divided by the total number of confirmed sperm tracks. An average percentage of sperms exhibiting non-progressive motility can be calculated as the sum of the percentage of sperms exhibiting non-progressive motility over all video frames divided by the total number of video frames. A percentage of non-motile sperms can be calculated as the total number of confirmed sperm tracks with curvilinear velocity <10 μm/sec. An average percentage of non-motile sperm can be calculated as the sum of the percentage of non-motile sperm over all video frames divided by a total number of video frames.

The method can further include classifying the spermatozoa into clinically significant categories.

Another aspect of the invention provides a non-transitory computer-readable medium containing program instructions executable by a processor. The computer-readable medium can include program instructions for performing a method as described herein.

Another aspect of the invention provides a system including: a processor and a computer-readable medium including program instructions for performing a method as described herein.

### BRIEF DESCRIPTION OF THE DRAWINGS

For a fuller understanding of the nature and desired objects of the present invention, reference is made to the following detailed description taken in conjunction with the following figures.

FIG. 1 depicts a general method for sperm tracking and analysis according to an embodiment of the invention.

FIG. 2 depicts a method of sperm pixel segmentation according to an embodiment of the invention.

FIGS. 3A-3D depict contrast stretching of video frames in accordance with an embodiment of the invention. FIG. 3A depicts an original video frame. FIG. 3B depicts a pixel grayscale value histogram for the image of FIG. 3A. FIG. 3C depicts a contrast-adjusted video frame based on the image of FIG. 3A. FIG. 3D depicts a pixel grayscale value histogram for the image of FIG. 3B. Vertical lines bounding the shaded regions in FIGS. 3B and 3D indicate the lower and upper contrast values.

FIG. 4A is a binarized image created by applying a gray level detection threshold. FIG. 4B depicts rectangular sub-images formed from each connected pixel groups. FIG. 4C depicts the results of applying the close, erode, and dilate morphological operators on the binarized image of FIG. 4A. FIG. 4D depicts the superimposition of Cartesian x-y coordinates of the connected pixel groups after morphological operations.

FIG. 5 depicts a method for multi-sperm tracking according to an embodiment of the invention.

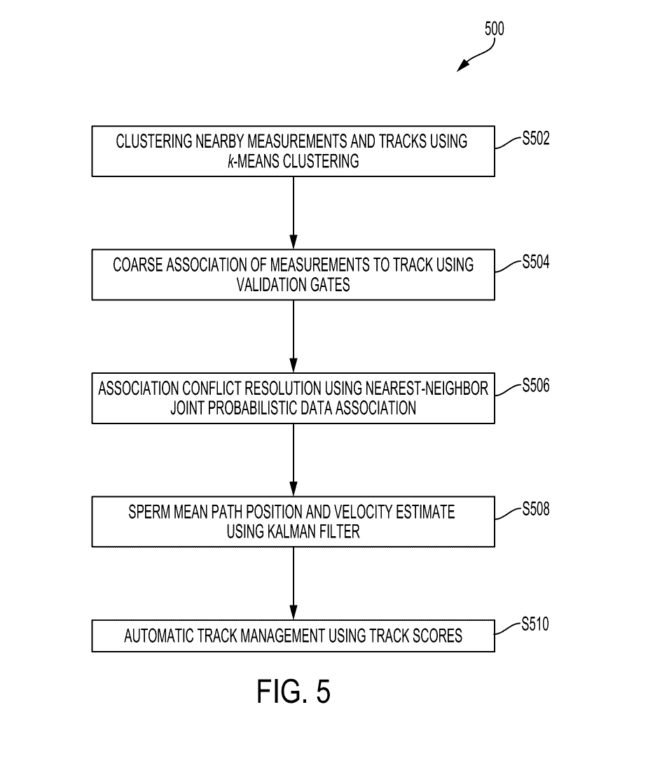

FIG. 6 is a video frame with superimposed sperm tracks and validation gates according to an embodiment of the invention. Fast sperm with erratic motion have larger validation gates because their j-point RMS displacement is large. Sperms with regular motion have smaller validation gates because their j-point RMS displacement is small. The difference in validation gate size improves the chances of correctly resolving association conflicts.

FIG. 7 depicts a method of automatic sperm track analysis according to an embodiment of the invention.

FIG. 8 provides an inverted phase contrast video recording frame in which track numbers are coded by font to signify the degree of forward progression for confirmed tracks according to an embodiment of the invention.

FIGS. 9A-9F provide a novel visualization of sperm motility measurements using time-lapse data animations in accordance with an embodiment of the invention. FIGS. 9A and 9B depict the estimated paths of every tracked sperm superimposed on top of the original video for a low motility sperm sample and a high motility sperm sample, respectively. FIGS. 9C and 9E provide bivariate histograms of curvilinear (VCL) vs. straight-line (VSL) sperm velocity measurements accumulated over 45 seconds for all sperm tracked for a low motility sperm sample and a high motility sperm sample, respectively. FIGS. 9D and 9F provide bivariate histograms of path linearity (LIN) vs. amplitude of lateral head displacement (ALH) measurements accumulated over 45 seconds for all sperm tracked for a low motility sperm sample and a high motility sperm sample, respectively.

FIG. 10 depicts a system according to an embodiment of the invention.

FIG. 11 depicts simulated random scenes of sperm at (from left to right) 30, 50, 70, and 90×10⁶ sperm/mL assuming 200× magnification.

FIG. 12, normalized histograms of measured VCL, VSL, LIN, and ALH obtained using GT tracks and estimated tracks for a simulated sperm concentration of 50×10⁶ sperm/mL according to an embodiment of the invention.

### DEFINITIONS

The instant invention is most clearly understood with reference to the following definitions:

As used in the specification and claims, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

Unless specifically stated or obvious from context, as used herein, the term “or” is understood to be inclusive.

### DESCRIPTION OF THE INVENTION

Aspects of the invention provide methods, computer-readable media, and systems for tracking a plurality of spermatozoa.

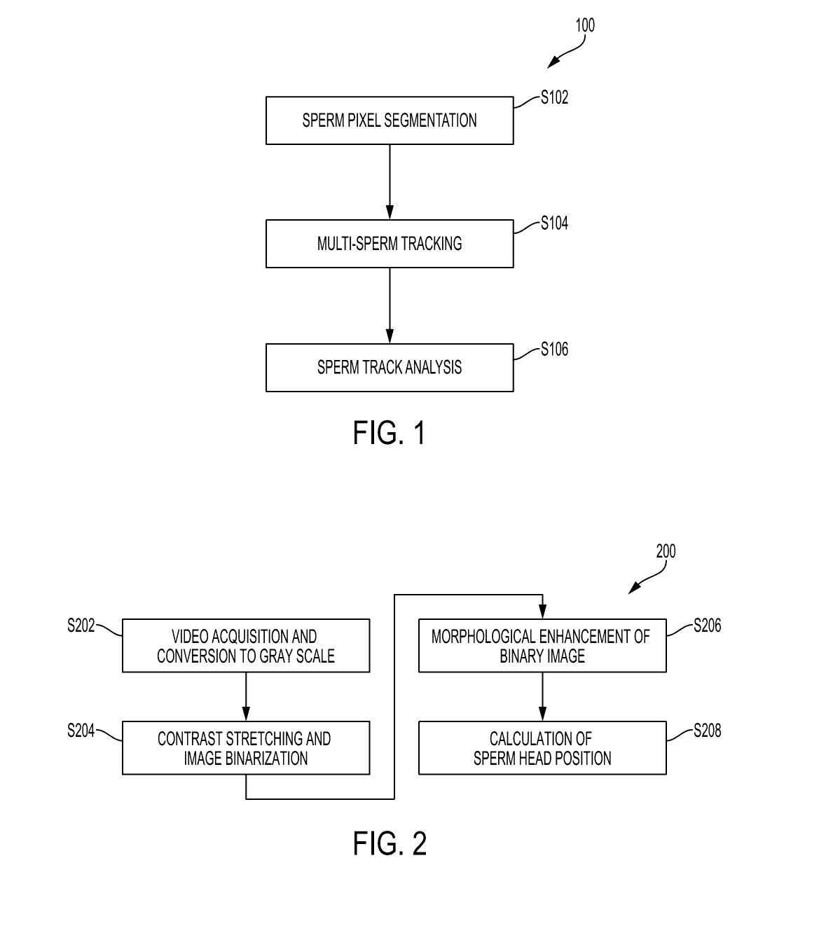

Referring to FIG. 1, a general method 100 for sperm tracking and analysis is provided including the steps of sperm pixel segmentation (S102), multi-sperm tracking (S104), and sperm track analysis (S106). Each of these steps is discussed in greater detail herein.

### Sperm Pixel Segmentation

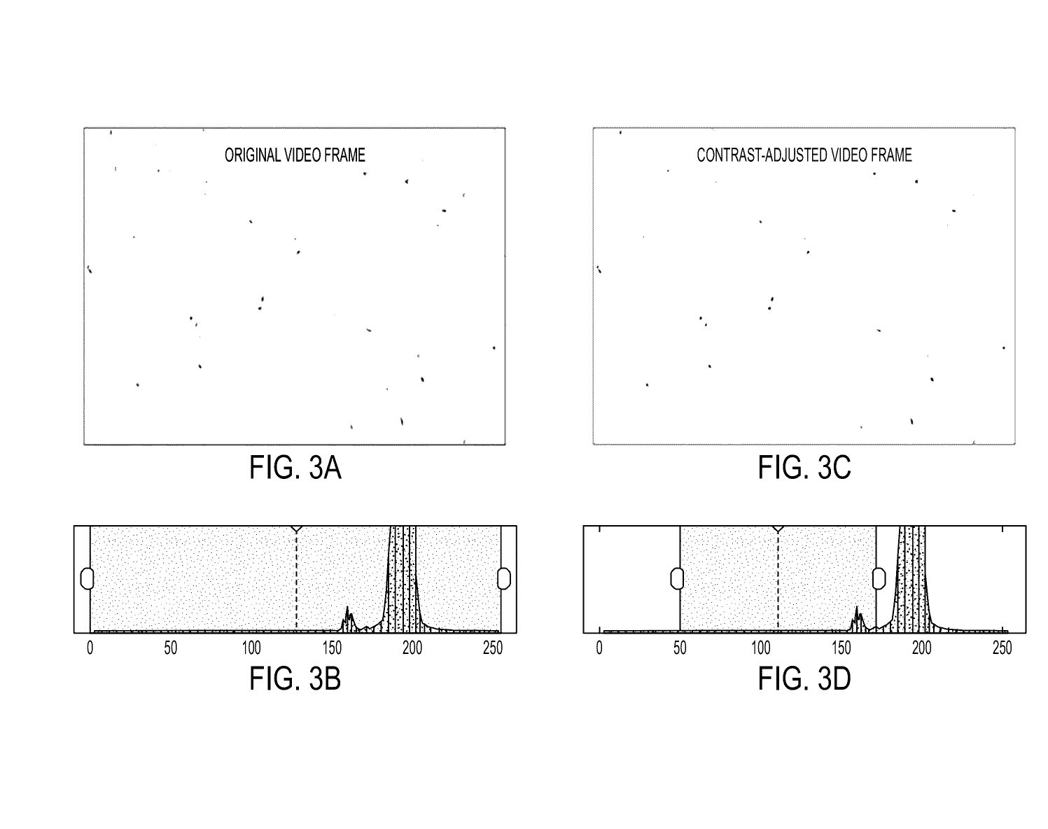

Pixel segmentation step S102 identifies the set of video frame pixels that belong to sperm cells, as opposed to those that belong to the video background or to non-sperm particles and debris. One method 200 for sperm pixel segmentation is depicted in FIG. 2 and includes the steps of: video acquisition and conversion to gray scale (S202), contrast stretching and image binarization (S204), morphological enhancement of the binary image (S206), and calculation of sperm head position by the centroid method (S208). Each of these steps is described below.

### Video Acquisition and Conversion to Gray Scale

In step S202, videos of sperm under microscopic magnification (e.g., 100×, 200×, 400×, and the like) are obtained, typically using phase contrast optics commonly available in research laboratories and fertility clinics. Phase contrast optics are preferred because sperm heads appear dark against a light background, which aids in the pixel segmentation process. However, the disclosed invention can accept videos collected using low-cost light microscopes as well.

A novel aspect of the disclosed invention is that no special equipment is required to perform the analysis beyond typical digital microscopes commonly available in most diagnostic laboratories. As a result, videos of recorded sperm samples can be transmitted via e-mail or uploaded to a website and processed remotely by aspects of the invention before results are sent back electronically to a medical professional within minutes for interpretation and diagnosis. Alternatively, video images of sperm can be captured and recorded using the same computer in which aspects of the invention are running.

Videos can be transmitted in a variety of formats including analog and digital. For example, the video can be saved in a format such as MPEG, MJPEG, AVI, QuickTime, and the like.

In addition, when aspects of the invention are optimized using computer languages suitable for real-time processing (such as C++) and graphics processing units (GPUs), the video signal can be processed directly and instantaneously in real-time. In this mode of the invention, videos can be recorded purely for archival purposes or to demonstrate reproducibility of the analysis results.

Either way, once videos are obtained, they can be converted to gray scale. The color information in the video is not needed to perform segmentation. In some pre-existing systems, color videos are required because special dyes and stains are used to identify sperms from non-sperm particles. Aspects of the invention do not require the use of stains or dyes, however aspects of the invention can be easily adapted to utilize such techniques to aid in the segmentation.

### Contrast Stretching and Image Binarization

After the video of a sperm sample is acquired, an automatic adjustment of the contrast of each image frame is performed using contrast stretching followed by a binarization process using a detection threshold.

To adjust the contrast of each video frame, aspects of the invention use contrast stretching. In contrast stretching, pixel values below a specified value are mapped to black, pixel values above a specified value are mapped to white, and pixel values in between these two values are mapped to shades of gray.

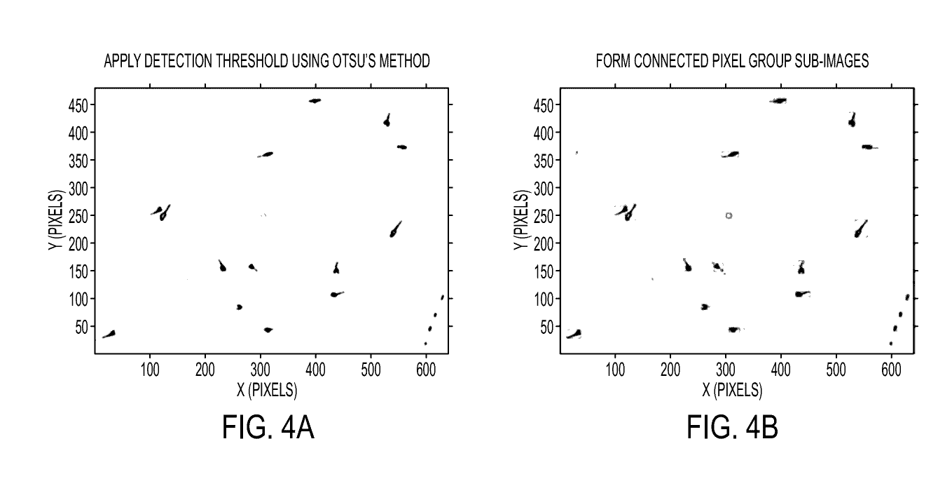

Aspects of the invention calculate the upper and lower pixel values by examining the distribution of the frequency of occurrence of the pixel values in each frame. FIG. 3A shows a typical video frame and FIG. 3B depicts the corresponding pixel value distribution. In FIG. 3B, pixels belonging to sperm have low pixel values (between 50 and 150), pixels belonging to the image background have higher pixel values (between 100 and 255), and pixels belonging to the rectangular image boundary have even lower pixel values (between 0 and 50). (These ranges are only for expository purposes because the real range of values varies from frame to frame). The lower pixel value can be calculated by taking the mean pixel value and subtracting 7 standard deviations. The upper pixel value can be calculated by taking the mean pixel value and subtracting 5 standard deviations. More sophisticated techniques can also be applied, such as the method of Gaussian mixtures, to better select the pixel upper and lower level values.

After applying contrast stretching, a contrast-adjusted image is obtained and is depicted in FIG. 3C. The corresponding pixel value distribution is depicted in FIG. 3D.

After the video frame contrast has been stretched, a detection threshold can be applied to convert the gray level image into a binary image. The thresholding operation compares every pixel level to the threshold level; if a pixel level is above the threshold then that pixel is mapped to white (255) and if a pixel level is below the threshold then that pixel is mapped to black (0). This process “binarizes” the image into a black and white image with a set of pixels having only values 0 and 255. In one embodiment, the detection threshold is calculated using Otsu's method as described in N. Otsu, “A Threshold Selection Method from Gray-Level Histograms,” 9(1) IEEE Transactions on Systems, Man, and Cybernetics 62-66 (1979), which chooses the threshold to minimize the intra-class variance of the black and white pixels.

### Morphological Enhancement of the Binary Image

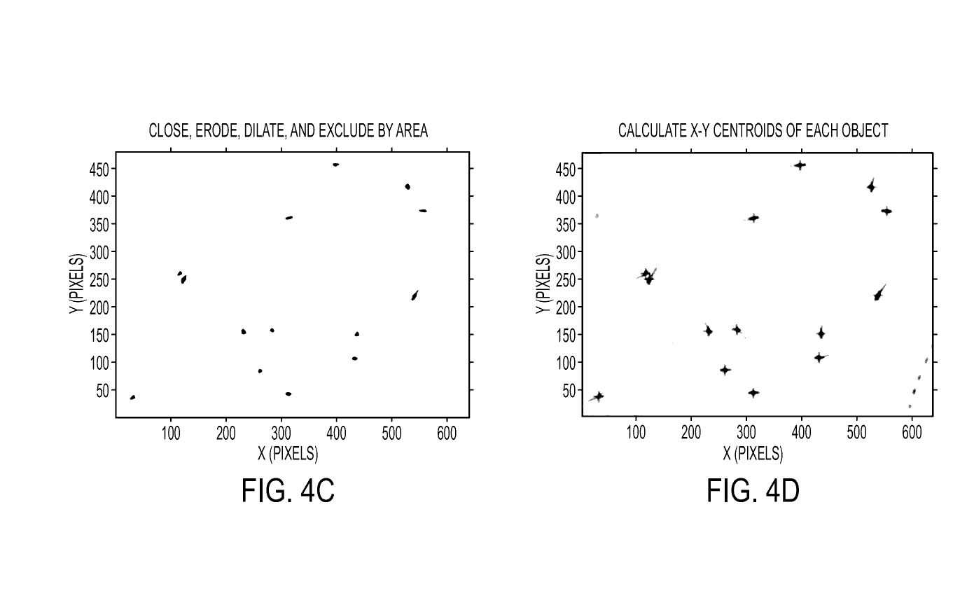

Since sperm heads viewed under phase-contrast microscope optics typically include bright pixels in their centers and dark pixels on their boundaries, some sperm heads show up deformed or have “holes” in the binarized image. After the image frame is binarized, the surviving groups of pixels can be enhanced in order to extract the necessary features for calculating the position of sperm heads. To do this, each set of connected pixels forms a sub-image and each sub-image can be enhanced using standard image processing morphological operators as depicted in FIG. 4.

Suitable morphological operators for each sub-image include, but are not limited to “close”, “erode”, and “dilate”. The “close” operator is used to fill gaps in a group of connected pixels, the “dilate” operator is used to add pixels to the boundaries of a group of connected pixels, and the “erode” operator is used to remove pixels from the boundaries or a group of connected pixels. The number of pixels added or removed from the objects depends on the size and shape of the structuring element used to process the image. Differently-sized structuring elements can be utilized depending on the magnification of the video image. An example of the morphological enhancement step can be seen in FIG. 4C relative to FIG. 4B.

### Calculation of Sperm Head Position Using the Centroid Method

After morphological operators are applied, the weighted-centroid of the pixels in each sub-image can be calculated and utilized as the X-Y position of a sperm head. The total area of the pixels in each sub-image can also be calculated and used to reject a centroid coordinate if the area is too small or too large to be a human sperm cell.

After calculating the centroids and applying the min/max area test to each sub-image, the set of all the coordinates of the detected sperm can be saved to a computer file and the entire process can be repeated on the subsequent frame. After all video frames have been processed and all centroids saved to a file, the computer file can be loaded by the multi-target tracking module described herein to track sperm cells.

### Multi-Sperm Tracking

Once individual sperm are identified from video frames, aspects of the invention can simultaneously track multiple sperm across the video, including during and after collisions in which two or more spermatozoa cross paths.

One aspect of the invention provides a method 500 for multi-sperm tracking including: clustering nearby measurements and tracks using k-means clustering (S502),

coarse association of measurements to track using validation gates (S504), association conflict resolution using nearest-neighbor joint probabilistic data association (S506), sperm mean path position and velocity estimation using a Kalman filter (S508), and automatic track management (initiation, confirmation, deletion) using track scores (S510).
Clustering Nearby Measurements and Tracks Using k-Means Clustering

One embodiment of the invention begins multi-sperm tracking by forming the set of all of the sperm head measurement coordinates for the current video frame and all of the predicted sperm track position coordinates. The task is to associate (or assign) each measurement to each track. This step can be daunting, especially when the total number of measurements and tracks is large (>200) because the total number of combinations of possible measurement-to-track associations can be prohibitive (hundreds of millions of combinations).

In one embodiment of the invention, instead of trying to perform measurement-to-track association using the entire set of measurements and tracks all at once, small groups—or “clusters”—of measurements and tracks are first created to reduce the computational throughput of the algorithm. The purpose of clustering is ultimately to make the algorithm run faster by eliminating extremely unlikely measurement-to-track pairings from consideration. Clustering prevents the algorithm from requiring an excessively long time to process sperm videos and ensures the invention's practicality in a clinical andrology laboratory setting.

There are many ways to form data clusters. In one embodiment, a k-means clustering algorithm to partition the total set of measurements and predicted track positions into k clusters based on their pairwise distance. Each resulting cluster contains a subset of the total set of measurements and tracks that are spatially near to one another. The k-means clustering algorithm permits control of approximately how many measurements and tracks will be grouped into each cluster. In one embodiment, the k-factor of the k-means algorithm is set equal to the total number of tracks divided by 10, which yields a set of clusters each having approximately 10 measurements and 10 tracks. Different k-values can be chosen by the user to trade the accuracy of the algorithm for increased processing speed, or vice versa.

Once the set of clusters has been created, data association can proceed by operating on each cluster separately.

### Coarse Association Using a Spatial Validation Gate

To perform coarse association, a circular validation gate is centered at the predicted position of each track in the cluster. The purpose of the gate is to geometrically select a subset of the measurements in the cluster for potential association with the track. Those measurements that lie inside the validation gate are candidates for association with the track, while those that lie outside the validation gate are excluded. The size of the validation gate is important to this step. If the validation gate is enormous, then many measurements will fall within it; if the validation gate is tiny, it is possible that no measurement will fall within it. The key to making the validation gate effective is to use the physics of sperm motion to choose an appropriate validation gate size. In many other sperm tracking systems, the validation gate is fixed and the same gate size is used for every track. Embodiments of the invention do not do this. Instead, embodiments of the invention calculate a unique validation gate size for each sperm based on the relative speed of the sperm observed over a period of time. This is more effective.

Embodiments of the invention determine the radius of the validation gate for each sperm by calculating the root mean square (RMS) of the position displacement over the last j frames (j=9 was used herein, but other values are possible and can be adjusted by the user if desired). As a result, slowly progressing sperm will have a smaller j-point RMS position displacement and therefore a smaller gate radius, while highly progressive sperm will have a larger j-point RMS position displacement and therefore a larger gate radius. In other words, the validation gate of a sperm track “breathes” as it is being tracked—growing and shrinking in size from frame to frame based on the observed motion of the sperm over the last j frames. The advantage of having different gate radii for sperm of different speeds is that the probability of two sperm with dissimilar motion sharing measurements in overlapping gates (and therefore potentially being incorrectly associated) is greatly reduced. In other pre-existing algorithms where a fixed validation gate is used for sperm motion tracking, the probability of association conflicts and of incorrect associations is greater. By having validation gates whose sizes are based on the observed motion of the sperms, aspects of the invention are more robust against association errors when multiple sperm are nearby.

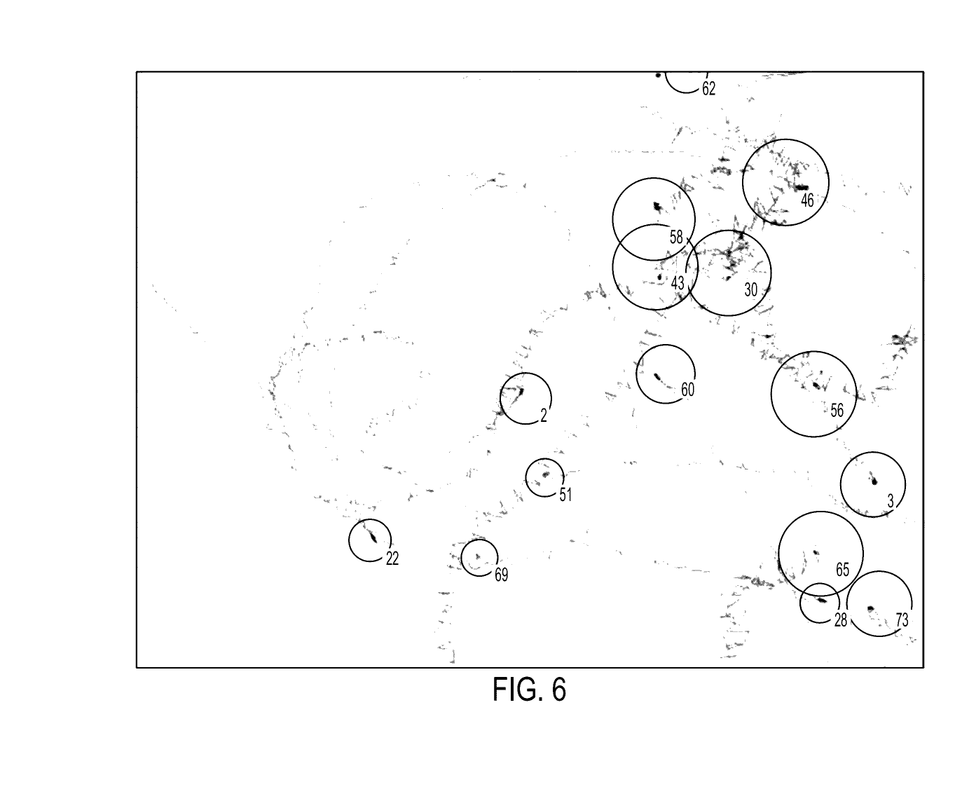

A video frame of sperm tracks and validation gates is provided as FIG. 6.

### Nearest Neighbor Joint Probabilistic Data Association (NN-JPDA)

When one or more measurements lie within one or more overlapping validation gates belonging to different sperm tracks, there is an association conflict that must be resolved. It is possible that each measurement belongs to a different track. It is also possible that some measurements are false detections (random clutter due to pixel segmentation errors). It is also possible that a spermatozoa was not detected and therefore there is no measurement to associate with its track. In any situation involving a set of measurements in conflict with a set of tracks, there are many possible association hypotheses. The problem to solve is: which hypothesis is correct?

In many previous sperm tracking systems, this problem was side-stepped by simply deleting the tracks belonging to all sperm in conflict. This approach is highly suboptimal both in general because data is discarded and specifically because faster sperm are more likely to be involved in association conflicts. So by throwing away data, clinically useful information about a sperm sample is lost and can cause the fertility analysis results to be biased toward the slower cells. Association conflicts are unavoidable when analyzing sperm samples having high concentrations. Therefore, failing to solve the association conflict problem is a serious impediment to most pre-existing sperm tracking algorithms.

Embodiments of the invention solve the problem of association conflicts by using the approach of joint probabilistic data association (JPDA).

The central feature of the JPDA method is that it considers every feasible association hypothesis between measurements and tracks with overlapping validation gates. A key step in the JDPA algorithm is the calculation of every feasible association hypothesis. After all feasible association hypotheses are identified, their probabilities of being true can be calculated. Once the probabilities of each hypothesis are calculated, the final association probability between a measurement and a track can then be obtained by summing over every feasible association hypothesis that contains the measurement-to-track association event in question.

There are many implementations of the JPDA algorithm in the sonar, radar and multi-object tracking literature. Nearly all of them differ only in how they calculate the association hypothesis. Since the number of association hypotheses can be extremely large even for a few measurements and tracks in conflict, methods for accelerating the algorithm by only identifying the most highly probable association hypotheses have been used.

Embodiments of the invention use Murty's m-best ranked assignment method described in K. Murty, “An Algorithm for Ranking all of the Assignments in Order of Increasing Cost,” 16(3) Operations Research 682-87 (1968) to identify only the most highly probable measurement-to-track association events. By using Murty's method, we achieve a considerably faster implementation of the JPDA. Instead of identifying every possible association hypothesis, Murty's method allows for finding only the m most highly probable association events, which allows for considerably faster processing of the JPDA equations.

Another way that JPDA algorithms differ from one another is how they apply their answers to the association problem. In the standard formulation of the JPDA, if two measurements fall within the validation gate of a single track, then the probability-weighted combination of both measurements is used to form a pseudo-measurement that is then used to update the track. The pseudo-measurement lies along the line between the two measurements, and is therefore located at the position of neither of the two measurements. This feature of the JPDA can be useful when there are many false detections, but when there are many true detections (such as in scenes of high particle density), the probability-weighted updating step can lead to an undesirable merging of tracks, referred to “track coalescence”.

Embodiments of the invention do not use the probability-weighted updating step to update the tracks of each sperm. Instead, embodiments of the invention employ the so-called nearest-neighbor JPDA (NN-JPDA) approach described in R. Fitzgerald, “Development of Practical PDA Logic for Multitarget Tracking by Microprocessor,” in Proc. American Control Conference 889-98 (1986). In the NN-JPDA approach, after all of the association probabilities have been calculated between every measurement and every track sharing validation gates, the set of associations that maximizes the sum of the association probabilities is used to assign measurements to tracks. This method avoids track coalescence.

Up to this point, the measurements and tracks at a particular video frame have been grouped into clusters, validation gates have been calculated to perform coarse association, and NN-JPDA using Murty's m-best ranked assignment method has been used to solve any association conflicts by determining which measurements should be assigned to which tracks. The next step is to use the measurements in a linear Kalman filter to update each sperm track.

### Kalman Filter for Estimating the Mean Sperm Path

Once a measurement is assigned to a track, a Kalman filter is used to update the estimated sperm position and velocity. Embodiments of the invention employ a two-dimensional (X-Y) two-state (position-velocity) Kalman filter using a discrete white noise acceleration (DWNA) linear model of target motion. The DWNA model of target motion assumes the motion of a target is nearly constant velocity motion except for random accelerations assumed to be zero mean white Gaussian process noise.

In a Kalman filter based on the DWNA model, the value of the process noise is a tuning parameter and controls how much lag the filter has when tracking a target. If the process noise is set to a large value (i.e., for tracking targets that exhibit large accelerations/maneuvers), then the filtered target track will follow maneuvers (it has low lag) but will be noisy. Conversely, if the process noise is set to a small value (i.e., for tracking targets that exhibit small accelerations/maneuvers) then the filter track is less noisy (it has high lag) but may result in track loss during sudden target maneuvers. Choice of the filter process noise is a central design consideration in any Kalman filter.

Embodiments of the invention implemented a DWNA Kalman filter in a novel way. The motion of sperm was observed in video frames to identify that the sperm head moves in a zig-zag pattern. This zig-zag motion pattern corresponds to an enormously high target acceleration process noise level in the framework of the DWNA Kalman filter. When employing a DWNA Kalman filter with an enormously high process noise, the sudden direction changes of the sperm head could not be predicted with any accuracy and track loss would inevitably result.

Embodiments of the invention take a novel approach to overcome this problem. Rather than track the sperm head directly, embodiments of the invention track the mean path bisected by the zig-zag path of the sperm head. The mean path moves much more regularly and is closer to straight-line motion models and easier to predict.

Another novel aspect of the invention models the nearly random zig-zag sperm head motion as additional sensor noise that enables the use of a much smaller process noise acceleration. The smaller process noise causes the DWNA Kalman filter to estimate the mean path bisected by the sperm head zig-zag pattern, which is much easier to estimate than the sperm head position. This feature is also highly advantageous when performing data association because the predicted sperm head position is based on the mean path of the sperm, which is more regularly behaved than the random sperm head motion. As a result, a validation gate centered on the predicted mean path position is more likely to contain a measurement of the corresponding sperm head, since the head zig-zags about the mean path.

### Track Management

The disclosure up to this point assumes that tracks already exist, but has not discussed how tracks are initiated, confirmed or deleted. This process is referred to as track management and embodiments of the invention use the concept of a track score to make automatic decisions about track management.

Once a measurement is obtained for a track, the difference between the predicted sperm position and the measured sperm position is multiplied by the Kalman filter gain and used to update the sperm position and velocity states. This difference between measured and predicted sperm position is referred to as the filter residual and it serves as a useful measure of how good the track is. A small filter residual means that the predictions are very close to the measurements, and therefore, the corrections to the estimated position and velocity are small. A large filter residual means that the predictions are very different than the measurements, and therefore, the corrections are large.

Aspects of the invention use the filter residual and residual covariance matrix calculated in the standard Kalman filter equations to calculate a track score for each track. This track score is equal to the negative log likelihood of the normalized residual (i.e., the residual vector divided by the residual covariance matrix). At each frame, the track score is equal to the previous track score plus the new normalized residual. For a good track, the track score will be monotonically increasing. For a bad track, the track score will decrease. To make decisions about track continuation or track deletion, embodiments of the invention apply a Wald sequential probabilistic ratio test (SPRT) as follows and further described in Samuel Blackman & Robert Populi, Design & Analysis of Modern Tracking Systems §6.2.4 (1999): if the difference between a track's maximum score and its current score is between the upper and lower threshold of the SPRT test, the track is continued, otherwise delete the track.

Embodiments of the invention initiate tracks by simply creating tentative tracks on all measurements that have not been used to update any tracks. If these tentative tracks gate with any subsequent measurements, their tracks will be extended and their track scores will increase. If their track score exceeds a fixed confirmation threshold, then the track is confirmed. If the track is not updated by any measurements (i.e., it is a spurious detection/false track), its track score will decrement and it will eventually be deleted.

### Sperm Track Analysis

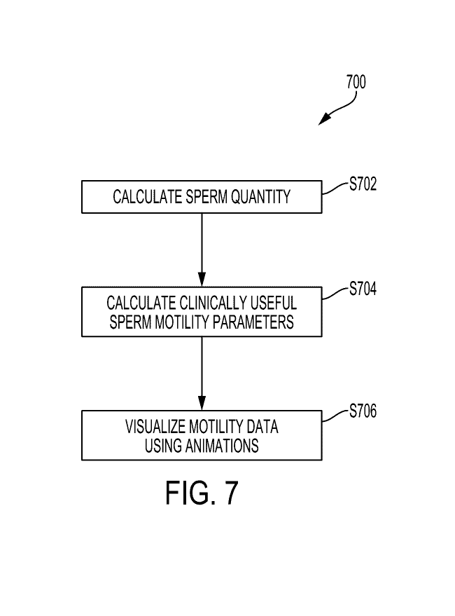

Referring now to FIG. 7, another aspect of the invention provides a method 700 for automatic sperm track analysis. The method 700 can include the steps of: calculating sperm quantity (S702), calculating clinically useful sperm motility parameters (S704), and visualizing motility data using animations (S706).

### Calculation of Sperm Numbers

The total concentration of sperm in an ejaculate and the percentage of sperms exhibiting progressive motility are both believed to have clinical significance in predicting infertility.

One embodiment of the invention calculates the total number of sperm as the total number of confirmed sperm tracks in a video frame. This number can be plotted as a function of the number of video frames so that an idea can be gained about how the total number of sperm within the confines of the video frame is changing over time. The mean value of the total number of sperm can be calculated as the total number of confirmed sperm tracks in every video frame divided by the total number of video frames. Both of these numbers can be converted into sperm concentration by applying appropriate conversions based on the magnification used to image the sperm sample, and the total volume of the ejaculate produced by the patient.

In another embodiment of the invention, the total percentage of motile sperm, the percentage of sperm exhibiting forward progression, and the percentage of sperm exhibiting non-progressive motility can be calculated using the measured curvilinear velocity (VCL) and path linearity (LIN) for each sperm. In each video frame: the percentage of motile sperm exhibiting forward progression are those with confirmed tracks having VCL>25 μm/sec and LIN>0.5, divided by the total number of confirmed sperm tracks; the percentage of motile sperm exhibiting non-progressive motility are those with confirmed tracks having VCL>10 μm/sec and LIN<0.5, divided by the total number of confirmed sperm tracks; and the percentage of non-motile sperm are those with confirmed tracks having VCL<10 μm/sec, divided by the total number of confirmed sperm tracks. Other suitable values within the typical characteristics of sperm can be used. For example, the upper boundary for immotile sperm could be a VCL of 30 μm/sec. The characteristics of sperm are further discussed in World Health Organization. Manual for the Examination and Processing of Human Semen (5th ed. 2010).

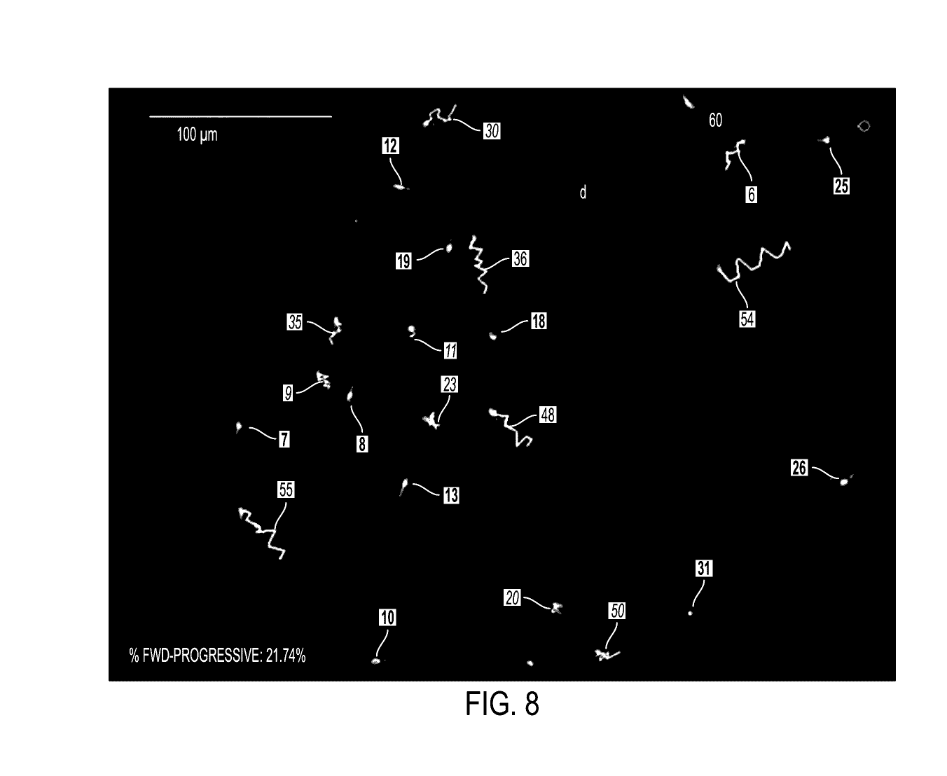

FIG. 8 provides an inverted phase contrast video recording frame in which track numbers are coded by font to signify the degree of forward progression for confirmed tracks. Track numbers represented with regular font (e.g., 6) are associated with sperm that are motile and forward progressive (VOL>25 μm/sec and LIN 0.5). Track numbers represented with italic font (e.g., 30) are associated with sperm that are motile and non-progressive (VOL>10 μm/sec and LIN<0.5). Track numbers represented with bold font (e.g., 25) are associated with sperm that are immotile (VOL<10 μm/sec). Track number 60 represents sperm that have new, unconfirmed tracks and is shown in white. Scale bars are 100 μm. All measurements are calculated using a 1 second moving average. The percentage of sperms exhibiting forward progression is 21.7%

Each of these percentages can be averaged over the total number of video frames to summarize the percentages over the entire video duration.

### Calculation of Clinically-Useful Sperm Motility Parameters

The set of position measurements belonging to a sperm track can be used to measure clinically-useful sperm motility parameters including: curvilinear velocity (VOL), straight-line velocity (VSL), path linearity (LIN), mean amplitude of lateral head displacement (ALH), and the like. Other parameters such as wobble (WOB), straightness (STR), beat cross frequency (BCF), and mean angular displacement (MAD) can also be calculated. There are many standard texts describing how these parameters can be calculated for a set of sperm position measurements. Embodiments of the invention utilize definitions given by the World Health Organization. Manual for the Examination and Processing of Human Semen (5th ed. 2010).

Novel aspects of the invention relating to measurement of motility parameters include that (1) sperm motility parameters can be calculated only for confirmed tracks and (2) the total number of measurements to be collected per sperm can be a control parameter of the algorithm.

Limiting motility measurements to confirmed tracks prevents any spurious tracks or measurements caused by erroneous segmentation from affecting the population measurements as a whole. Random measurement noise in the videos can sometimes exceed the detection threshold of the segmentation algorithm, survive morphological enhancements, become incorrectly identified as a sperm, and initiate a false track that will eventually be deleted. Such spurious tracks should not affect the measurements of the population statistics of VCL, VSL, LIN, etc. By using the track score calculated in the previous step, embodiments of the invention are robust against spurious tracks affecting measurements.

By limiting the total number of measurements per sperm, embodiments of the invention prevent slowly progressing sperm that tend to linger in the video frame from unduly biasing the analysis. A rapidly progressing sperm may enter the video frame, swim some distance and leave the video frame and therefore may only be analyzed for a few seconds (depending on the magnification). A slowly progressing sperm—or a dead sperm—typically remains in the video frame for a long time. If an unlimited number of measurements were allowed (constrained only by the duration of the video recording), then more sperm measurements would be collected for the slow sperm than for the fast sperm and the population statistics would be biased toward the slower cells. By limiting the total number of measurements per sperm, the sample measurements will be less biased and more meaningful to medical practitioners using aspects of the invention.

### Animated Visualization of Sperm Motility Data

After the sperm motility parameters have been collected for every confirmed sperm track in a sperm sample under analysis, a presentation or display of the data to medical practitioners is needed that conveys the most diagnostically useful information possible. Prior sperm analysis systems typically output a simple spreadsheet showing the mean value of the calculated VCL, VSL, LIN, ALH, STR, WOB, BCF, and ALH taken over all sperm over all time. Usually, videos of only 1 second in duration are used because most existing sperm analysis equipment is unable to track sperms in close proximity or through collisions. This “snapshot” of data hides the temporal dynamics of the data, which may reveal clinically important features of the data.

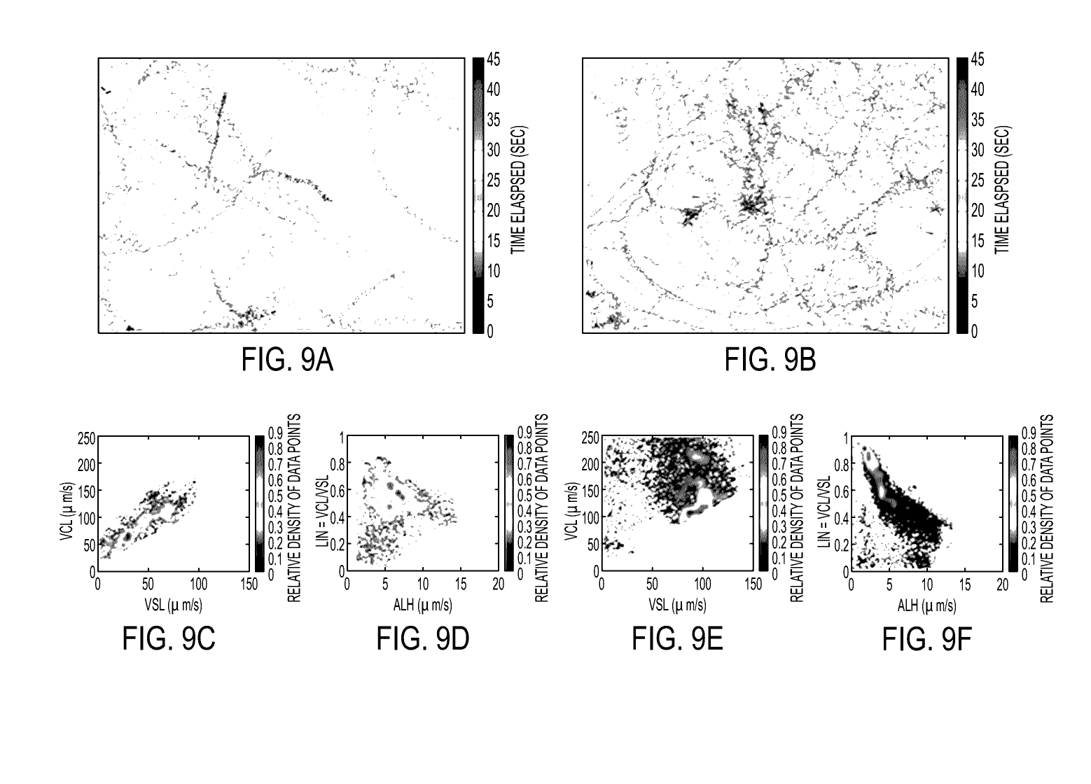

Embodiments of the invention provide a novel visualization of sperm motility measurements using time-lapse data animations, samples of which are depicted in FIGS. 9A-9F. Namely, the same video used to perform the sperm motility analysis is re-played and the estimated paths of every tracked sperm is superimposed on top of the original video, along with the validation gate sizes and a unique track number for every sperm in the video frame. Accompanying this video playback superimposed with track paths are two bivariate histograms: (1) VCL vs. VSL and (2) LIN vs. ALH. These histograms are plotted as a colored “heat map” with color corresponding to the relative density of data points. As the original video is played back, the animated heat map is updated to reflect the summary statistics of the data collected up to the frame being displayed. As the video is played, the histogram is “alive” and shows the data analysis in a dynamic way.

The presentation of the collected sperm motility measurements using animated histograms together with sperm track paths superimposed on the original sample video can enable interpretations of data by doctors and specialists that were previously impossible using existing methods.

Implementation in Hardware and/or Software

The methods described herein can be implemented on general-purpose or specially-programmed hardware or software. The exemplary implementations described herein were programmed using MATLAB® software from The Math Works, Inc. of Natick, Mass. Production versions could be programmed in other programming languages such as C/C++ and the like.

For example, the methods can be implemented in instructions stored a computer-readable medium. The computer-readable medium can be non-transitory and/or tangible. For example, the computer-readable medium can be volatile memory (e.g., random access memory and the like) or non-volatile memory (e.g., read-only memory, hard disks, floppy discs, magnetic tape, optical discs, paper table, punch cards, and the like).

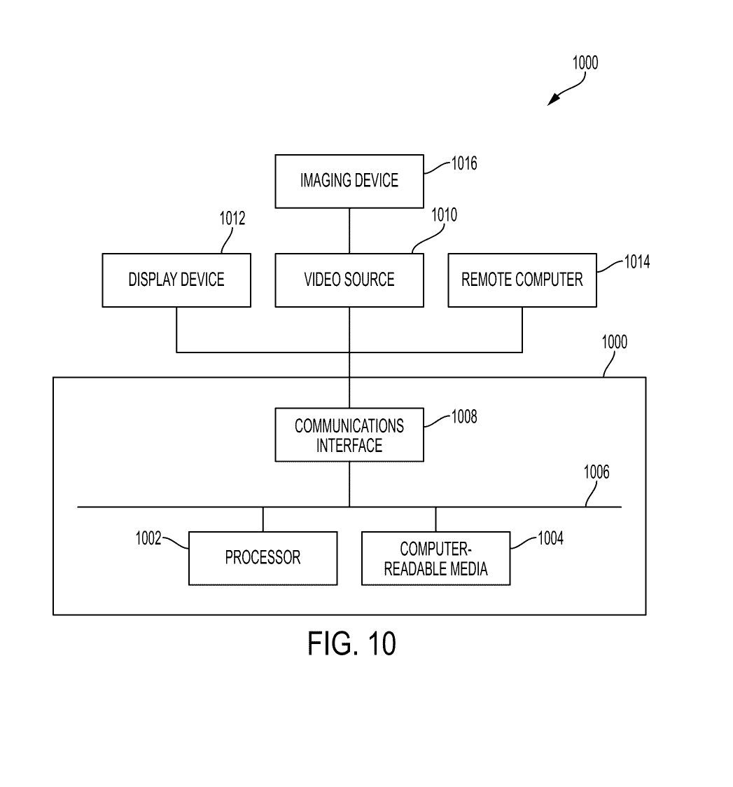

Referring to FIG. 10, the methods described herein can be implemented by a system 1000. System 1000 can include a processor 1002 and a computer-readable medium 1004 in communication with the processor 1002 (e.g., through a bus 1006).

System 1000 can further include a communications interface 1008 for communication with a video source 1010, a display device 1012, and/or remote computer 1014. For example, system 1000 can be installed in a laboratory setting proximal to an imaging device 1016. In such an embodiment, video can be transmitted from the video source 1010 coupled with the imaging device 1016 via various standards such as HDMI, Universal Serial Bus (USB), USB 2.0, Firewire, and the like. In another embodiment, system 1000 can communicate with video source 1010 via a networking standard such as Ethernet, Gigabit Ethernet, and the like.

System 1000 can also transmit its results to a user using the same or similar networking standards and/or can display the results on a display device 1012 such as a cathode ray tube (CRT), a plasma display, a liquid crystal display (LCD), an organic light-emitting diode display (OLED), a light-emitting diode (LED) display, an electroluminescent display (ELD), a surface-conduction electron-emitter display (SED), a field emission display (FED), a nano-emissive display (NED), an electrophoretic display, a bichromal ball display, an interferometric modulator display, a bistable nematic liquid crystal display, and the like.

### Working Example—Algorithm Validation Using Simulated Ground Truth Sperm Scenes

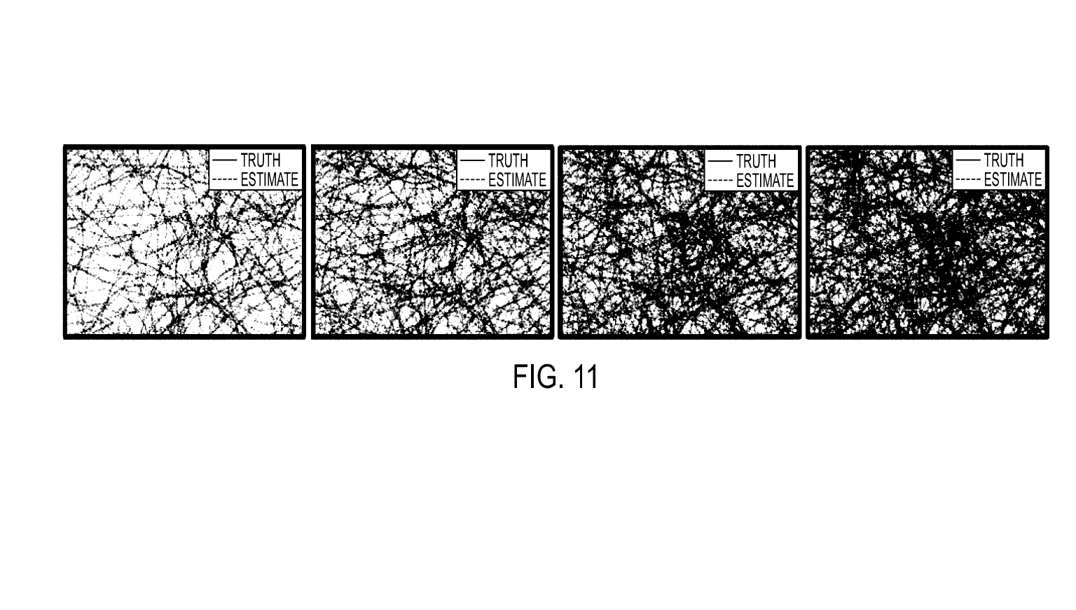

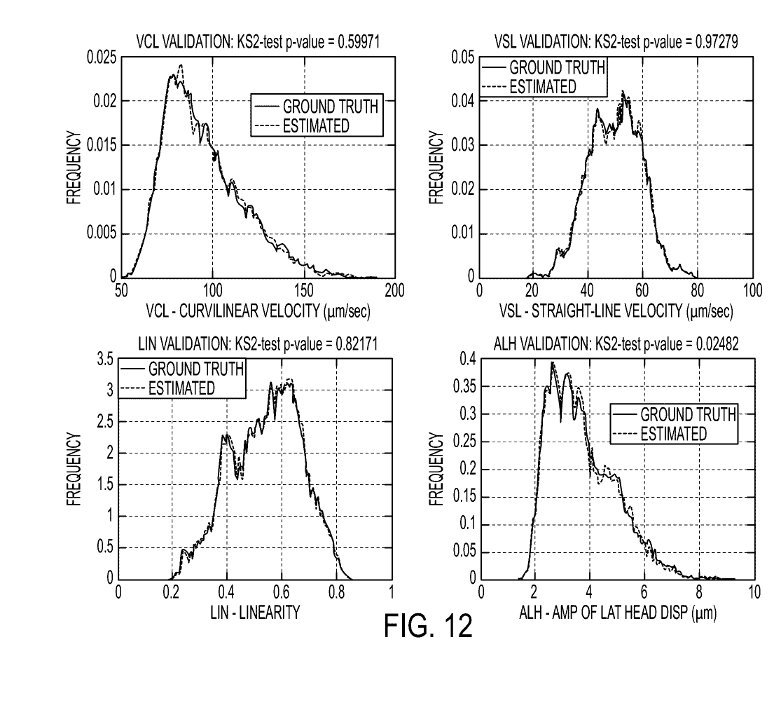

Simulated random scenes of sperm were generated assuming 200× magnification and are depicted in FIG. 11. Sperm trajectories were generated using equations of motion for a persistent random walk with a swimming direction angle that undergoes rotational diffusion as described in I. Armonn, “Testing human sperm chemotaxis: how to detect biased motion in population assays,” 7(3) PLoS ONE e32909 (2012). Simulated measurements were created from these scenes and fed into the tracking algorithm to create estimated sperm tracks. Simulated sperm motility was analyzed using the ground truth (GT) tracks and estimated tracks. To compare the algorithm described herein to perfect tracking, a two-sample Kolmogorov-Smirnov test was performed on the measured VCL, VSL, LIN, and ALH obtained from the GT tracks and estimated tracks and are depicted in FIG. 12.

Referring still to FIG. 12, normalized histograms of measured VCL, VSL, LIN, and ALH obtained using GT tracks and estimated tracks for a simulated sperm concentration of 50×10⁶ sperm/mL. The p-value on each graph is from a two-sample Kolmogorov-Smirnov test using the measurements obtained from the GT tracks and those obtained from the estimated tracks. A p-value >0.05 indicated the measured sperm motility parameters obtained using GT tracks are statistically similar to the measurements obtained using estimated tracks produced by the algorithm described herein.

### INCORPORATION BY REFERENCE

All patents, published patent applications, and other references disclosed herein are hereby expressly incorporated by reference in their entireties by reference.

### EQUIVALENTS

While the present subject matter has been described with reference to the above

embodiments, it will be understood by those skilled in the art that various changes can be made and equivalents can be substituted for elements thereof without departing from the scope of the subject matter. In addition, many modifications can be made to adapt a particular situation or material to the teachings of the subject matter without departing from the essential scope thereof. Therefore, it is intended that the subject matter not be limited to the particular embodiment disclosed as the best mode contemplated for carrying out this subject matter, but that the subject matter will include all embodiments falling within the scope of the appended claims.

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, computers, and the like) shown as distinct for purposes of illustration can be incorporated within other functional elements, separated in different hardware or distributed in a particular implementation.

While certain embodiments according to the present subject matter have been described, the present subject matter is not limited to just the described embodiments. Various changes and/or modifications can be made to any of the described embodiments without departing from the spirit or scope of the present subject matter. Also, various combinations of elements, steps, features, and/or aspects of the described embodiments are possible and contemplated even if such combinations are not expressly identified herein.

1. A computer-implemented method for tracking a plurality of spermatozoa, the method comprising:
identifying a coordinate for each of the plurality of spermatozoa in a plurality of video frames; and
applying a nearest-neighbor joint probabilistic data association filter (NN-JPDAF) algorithm to associate the coordinates with one or a plurality of sperm tracks.

2. The method of claim 1, further comprising:
applying a sperm segmentation algorithm to a plurality of video frames to identify sub-images potentially representing spermatozoa within the plurality of video frames.

3. The method of claim 2, wherein the sperm segmentation algorithm includes:
converting the plurality of video frames to grayscale.

4. The method of claim 2, wherein the sperm segmentation algorithm includes:
applying a detection threshold to a plurality of pixels within the plurality of video frames to produce a plurality of binary black-and-white images corresponding to the plurality of video images.

5. The method of claim 2, wherein the sperm segmentation algorithm includes:
applying Otsu's method to produce a plurality of binary black-and-white images corresponding to the plurality of video images.

6.-10. (canceled)

11. The method of claim 1, further comprising:
applying a multi-target tracking algorithm to estimate a mean sperm head position for each of the plurality of sperm tracks.

12. The method of claim 11, wherein the multi-target tracking algorithm is selected from the group consisting of: a Kalman filter, an extended Kalman filter, a generalized pseudo-Bayesian estimator, a first-order generalized pseudo-Bayesian estimator, a second-order generalized pseudo-Bayesian estimator, and an interacting multiple model algorithm.

13.-20. (canceled)

21. The method of claim 1, further comprising:
calculating a track score for each sperm track using a filter residual and residual covariance matrix.

22. The method of claim 21, wherein a track is deleted if a difference between its current track score and a maximum track score over its track history exceeds a track deletion threshold.

23. The method of claim 21, wherein a track is confirmed if its track score exceeds a track confirmation threshold.

24. The method of claim 1, further comprising:
coarsely associating measurements to each sperm track using a circular validation gate whose radius is calculated as a root mean square of a spermatozoa's spatial displacement over n most recent video frames, wherein n is a positive integer.

25. The method of claim 1, further comprising:
calculating the total number of sperms in a sperm sample as the total number of confirmed tracks in every video frame divided by the total number of video frames.

26. The method of claim 25, wherein a percentage of motile sperms exhibiting progressive motility is calculated as the total number of confirmed sperm tracks whose measured curvilinear velocity >25 μm/sec and path linearity >0.5, divided by the total number of confirmed sperm tracks.

27. The method of claim 26, wherein an average percentage of sperms exhibiting forward progression is calculated as the sum of the percentage of sperms exhibiting forward progression over all video frames divided by the total number of video frames.

28. The method of claim 25, wherein a percentage of motile sperms exhibiting non-progressive motility is calculated as the total number of confirmed sperm tracks whose measured curvilinear velocity >10 μm/sec and path linearity <0.5, divided by the total number of confirmed sperm tracks.

29. The method of claim 28, wherein an average percentage of sperms exhibiting non-progressive motility is calculated as the sum of the percentage of sperms exhibiting non-progressive motility over all video frames divided by the total number of video frames.

30. The method of claim 25, wherein a percentage of non-motile sperms is calculated as the total number of confirmed sperm tracks with curvilinear velocity <10 μm/sec.

31. The method of claim 30, wherein an average percentage of non-motile sperm is calculated as the sum of the percentage of non-motile sperm over all video frames divided by a total number of video frames.

32. (canceled)

33. A non-transitory computer-readable medium containing program instructions executable by a processor, the computer-readable medium comprising:
program instructions for performing the method of claim 1.

34. A system comprising:
a processor; and
a computer-readable medium including program instructions for performing the method of claim 1.
